(19) United States
(12) Patent Application Publication
(10) Pub. No.: US 2023/0045549 A1
(43) Pub. Date: Feb. 9, 2023

(54) BAG MOUTH

(71) Applicant: Frederick John Tadda, Kaneohe, HI (US)

(72) Inventor: Frederick John Tadda, Kaneohe, HI (US)

(21) Appl. No.: 17/871,388

(22) Filed: Jul. 22, 2022

Related U.S. Application Data
(60) Provisional application No. 63/224,708, filed on Jul. 22, 2021.

(51) Int. Cl. B65B 67/12

(52) U.S. Cl. CPC B65B 67/1255; B65B 67/1233

(57) ABSTRACT

An embodiment provides a portable bag mouth opening device, the device including: an outer portion including a continuous side portion defining an interior opening; and an inner portion including a continuous side portion and defining an interior opening, the inner portion fitting within the outer portion to form the portable bag mouth opening device, wherein the outer portion and inner portion fit together to hold a bag material between the outer portion and the inner portion. Other aspects are claimed and described.

### CROSS REFERENCE TO RELATED APPLICATIONS

This application claims priority to U.S. Provisional Application Ser. No. 63/224,708, filed on Jul. 22, 2021, titled “Bag Mouth,” the contents of which is incorporated by reference herein.

### BACKGROUND

Plastic and other collapsible bags are commonly used for many tasks, for example, grocery bags, trash bags, storage bags, and the like. The fact that these types of bags can be collapsed and have no support or form makes them easy to transport and store when not in use. However, when opened, the bags are of a size that allows for a user to carry multiple objects within the bag, thereby allowing a user to carry more items than the user may be able to without a bag. Additionally, these bags are generally lightweight which means that the bag itself does not add to the weight of the items that are placed within the bag. However, even though the bags are lightweight the bags are generally made of materials that allow the bags to hold objects that are heavier than the bags itself. Thus, these bags are attractive to users who are looking for something lightweight, easy to store and transport, and that can carry multiple and sometimes heavy objects at a single time.

### BRIEF SUMMARY

One aspect provides a portable bag mouth opening device, the device including: an outer portion including a continuous side portion defining an interior opening; and an inner portion including a continuous side portion and defining an interior opening, the inner portion fitting within the outer portion to form the portable bag mouth opening device, wherein the outer portion and inner portion fit together to hold a bag material between the outer portion and the inner portion.

Another aspect provides a portable bag mouth opening device, the device including: an outer portion made of a flexible material and including a continuous side portion defining an interior opening; and an inner portion made of a flexible material and including a continuous side portion and defining an interior opening, the inner portion fitting within the outer portion to form the portable bag mouth opening device, wherein the outer portion and inner portion fit together to hold a bag material between the outer portion and the inner portion; wherein the inner portion and the outer portion are produced from a single continuous piece of material; and wherein the continuous side portion of the outer portion and the continuous side portion of the inner portion provide a flat edge for holding the portable bag mouth opening device against a surface, wherein the flat edge is provided via pressing the bag mouth opening device against a surface.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an illustrative example of a portable bag mouth opening device in use while holding a bag material.

FIG. 2 illustrates an illustrative example of a portable bag mouth opening device.

FIG. 3 illustrates an illustrative example side view of a portable bag mouth opening device in use while holding a bag material and having canted side portions.

FIG. 4 illustrates an illustrative example side view of a portable bag mouth opening device in use while holding a bag material and having clips holding the inner portion and outer portion.

FIG. 5A illustrates an illustrative example side view of a portable bag mouth opening device in use while holding a bag material and including interior protrusions.

FIG. 5B illustrates an illustrative example front view of a portable bag mouth opening device in use while holding a bag material and including interior protrusions.

FIG. 6A illustrates an illustrative example of single piece portable bag mouth opening device and including adjustment mechanisms.

FIG. 6B illustrates an illustrative example of a single piece portable bag mouth opening device during assembly.

FIG. 6C illustrates an illustrative example top-side view of an assembled single piece portable bag mouth opening device.

FIG. 6D illustrates an illustrative example side view of an assembled single piece portable bag mouth opening device.

FIG. 7 illustrates an illustrative example front view of a portable bag mouth opening device in use while holding a bag material and having an adjustment mechanism.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

The fact that plastic and other collapsible bags have no support or form makes the bags easy to store and transport. However, the lack of support or form means that the bags will collapse as soon as the bag is set down or is no longer supported by something else, for example, a user, a stand, and/or the like. For example, if a user opens the bag and then sets it on the ground, the bag will collapse towards the ground, which may result in dumping contents of the bag on the ground. As another example, if a user is attempting to place things in the bag, as soon as the user lets go of the bag, the bag will collapse and close. Thus, the user has to open the opening or mouth of the bag every time the user wants to put something new in the bag or take something out of the bag.

If the user is working at a repetitive task where the user is frequently putting things in the bag, it becomes annoying and cumbersome to continually have to open the bag to put the objects in the bag. Additionally, this additional step adds time to the task. While opening the bag can be performed very quickly, if this action has to be taken many times, the time spent opening the bag will add up over the time of the task. As an example, if a user is picking up trash and putting the trash in a plastic bag, the user has to open the bag every time the user wants to put a new piece of trash in the bag. As another example, if a user is pulling weeds and putting the weeds in a collapsible bag, every time the user has a weed or handful of weeds to put in the bag, the user has to open the bag. In these examples, it should be noted that at least one hand of the user is occupied holding the trash or weeds, which means opening the bag may be more difficult because the user is attempting to perform this action with a single hand.

Accordingly, the described system and device provides a device to hold open the opening of a bag, thereby allowing the user to place objects into the bag or take objects out of the bag without having to continually and repetitively open the opening of the bag. The bag mouth opening device is a portable device that allows the user to place the device on any bag and carry the bag mouth opening device and the bag in one hand. The portable bag mouth opening device includes an outer portion and an inner portion. Both the outer and inner portions are a continuous side portion that define an interior opening. As an example, the outer and inner portions are a strip of material that are formed in a ring that has an opening. It should be noted that the term ring does not necessarily mean that the device is circular in shape. Rather, ring only indicates that the device is enclosed without a top or bottom.

A top of the bag material can be draped over the inner portion and the outer portion is then placed over the inner portion, thereby pinning or holding the bag material between the inner portion and the outer portion. Thus, the inner portion fits within the outer portion to form the portable bag mouth opening device and hold a bag material between the inner and outer portion. The portable bag mouth opening device may have additional features, for example, a handle, protrusions on the inner and outer portion to assist in holding the bag material between the inner and outer portions, a strap that can be attached to the bag device and then placed on the user to free the hands of the user, adjustment mechanisms for changing a size of the bag device for different sized bags, a flat portion, and/or the like. The bag device may be made of different materials that may have different features. For example, the bag device may be made of a flexible material that allows the user to hold the bag device against a surface and create a flat surface for easily dragging or sweeping things into the bag. The material may also be a recycled material to decrease the environmental impact of manufacturing the bag device.

The illustrated example embodiments will be best understood by reference to the figures. The following description is intended only by way of example, and simply illustrates certain example embodiments.

The portable bag mouth opening device is designed to be utilized with a plastic bag, canvas bag, recycled material bag, paper bag, or other collapsible bag in order to hold the opening of the bag open without requiring the use of another object, like the user's hand, to open the bag. Additionally, with the use of the portable bag mouth opening device, when the bag is placed on a surface, for example, the floor, the ground, and/or the like, the mouth or opening of the bag will not collapse and close, thereby not requiring the user to keep reopening the bag to place objects within or take objects out of the bag. The portable bag mouth opening device is designed to be portable or handheld, meaning the device can be carried, with or without a bag, as opposed to being stationary or fixed at a particular point, like a stationary trash receptacle. It should be noted that the portable bag mouth opening device could be placed on or at a fixed location, but this would be temporary in the sense that it could be easily picked up and moved to a new location, without requiring the device to be disassembled to move the device.

Since the portable bag mouth opening device is designed to be portable, the device is made of relatively lightweight material, for example, plastic, lightweight and thin metal, heavyweight paper or paper stock, silicon, and/or the like. In this case, lightweight refers to a material that is easily carried and does not substantially increase the weight of the bag itself. A heavy material would cause a user to become fatigued while using the device, particularly if the device and bag is being carried by the user. Accordingly, lightweight, in this device application, is thought of as less than five pounds. It should be noted that the device could be used in more industrial applications and, therefore, a more robust material may be desired. In this case, the device may be made of a heavier material, but one that can still be moved by a user so that it can be used and applied to different bags, for example, as one bag is filled, the device can be moved to another empty bag.

The portable bag mouth opening device may be made of flexible material or may be made of rigid material. The material that is chosen for the device may be a material that can withstand multiple uses without deteriorating to the point of becoming unusable. For example, if the device is made of a flexible material, the material may be one that can be flexed many times before becoming unusable so that the device can be used on many different bags instead of only a single or a couple of bags. The material may also be a recycled material or the material may include a recycled material, for example, recycled plastic, recycled metal, a composite of recycled plastic and other material, and/or the like.

FIG. 1 illustrates an example of the portable bag mouth opening device while in use with a bag. The portable bag mouth opening device 100 includes an outer portion 101 and an inner portion 102. This example device 100 includes a handle for carrying. A top portion of the bag 104 is draped over the inner portion 102 and the outer portion 101 is then placed over the inner portion 102, thereby pinning or holding the bag 104 between the outer portion 101 and the inner portion 102. In this example, the device 100 is in a D-shape, thereby providing a flat surface or edge. This flat edge can be useful when placing the bag on a surface, for example, the ground, the floor, and/or the like, and sweeping, pushing, or pulling objects into the bag. Without the device 100 in place and in the described configuration of the bag on the surface, the opening of the bag would collapse and close, thereby preventing a user from being able to get objects into the bag without re-opening the bag. With the device 100, the opening of the bag is held open without the user having to hold the bag open.

FIG. 2 illustrates an example of the portable bag mouth opening device without a bag material in place. Each of the outer portion 101 and the inner portion 102 are formed of a continuous side portion that defines an interior opening. It should be noted that continuous does not necessarily mean that the side portion is a single piece or that the single piece is not an unbroken piece. Rather, continuous means that, when assembled, each of the portions has no gaps. However, this can be accomplished using multiple pieces that are connected together, for example, welded, riveted, screwed, held with a removable fastener, held with an adjustable fastener, and/or the like. It can also be accomplished using a single piece that is formed into the ring and then connected together at the ends. Thus, the continuous piece does not have to be molded or manufactured as a single non-broken piece, but it could be.

As seen in FIG. 2, the continuous side portion forms a ring that does not have a top or bottom, thereby providing or defining an interior opening that is open at the top and bottom of the device. Thus, when the device is in use having a bag placed between the inner and outer portion, the user can place an object at the top of the device and the object will fall into the bag. If a bag were not in place, the object would be placed at the top of the device and would fall through the device past the bottom of the device. This same action occurs when a bag is in place, except the object falls into the bag as opposed to on the ground. It should be noted that the term ring does not refer to the shape of the device, but rather simply indicates that the device is an uninterrupted side portion with no gaps.

The shape of the device may vary, for example, it may be a D-shape as illustrated in FIG. 1 and FIG. 2, a generally circular, including oval, shape, a square shape, a rectangular shape, an octagonal shape, or any other unbroken shape. If the shape of the device does not include a flat side or edge, the device may be made of a flexible material that allows a user to press the device against a surface to create a flat edge. As an illustrative example and to provide perspective, the height of the side portion may be between two and six inches. However, other sizes can be used and may be chosen based upon the application the device will be used in.

As illustrated in FIG. 2, the inner portion 102 fits within the outer portion 101 to engage and hold or pin the bag material, not shown, in place. Thus, the inner portion 102 is generally of a slightly smaller size than the outer portion 101, thereby allowing the inner portion 102 to nest within the outer portion 102. It should be noted that the inner portion 102 does not have to fully nest within the outer portion 101. Stated differently, the outer portion 101 does not have to fully overlap the inner portion 102 when the two pieces are together. Thus, the inner portion 102 may stick up from the outer portion 101, even when the inner portion 102 is fully seated within the outer portion 101. How much the inner portion 102 sticks up from the outer portion 101 may vary with different bag materials that have differing thicknesses.

Different techniques may be utilized to prevent the inner portion 102 from falling out of the bottom of the outer portion 101. For example, the two portions 101 and 102 may be connected together via a connection or coupling mechanism, for example, a hinge, a flexible material, a handle portion (illustrated in FIG. 1 and FIG. 2 at 103), and/or the like. In the case of a hinge or other mechanical coupler, the hinge may provide not only a mechanism for connecting the two portions 101 and 102, but may also provide a flat surface for holding the device against a surface and/or a handle for the device 100.

The device 100 may also be two separate or separable pieces. In this case, the device may be manufactured to prevent the inner portion 102 from falling through the outer portion 101 without the use of the coupling between the two portions 101 and 102. For example, FIG. 3 illustrates a side view of an example portable bag mouth opening device. In this example, the outer portion 101 and the inner portion 102 are canted. In this example, the interior opening of both the inner portion 102 and the outer portion 101 is narrower at the bottom of the device as compared with the interior opening of the portions at the top of the device. In other words, the diameter of the interior opening at the top of the device is greater than the diameter of the interior opening at the bottom of the device. This canting prevents the inner portion 102 from falling through and out of the outer portion 101. This example illustrates the bag material 104 between the two portions 101 and 102. It should be noted that the gap between the two portions 101 and 102 illustrated in this figure and other figures is exaggerated for understanding. In practice, the gap may be minimal or almost nil when the inner portion 102 is engaged and seated within the outer portion 102. The size of the gap may vary with the thickness of the bag material.

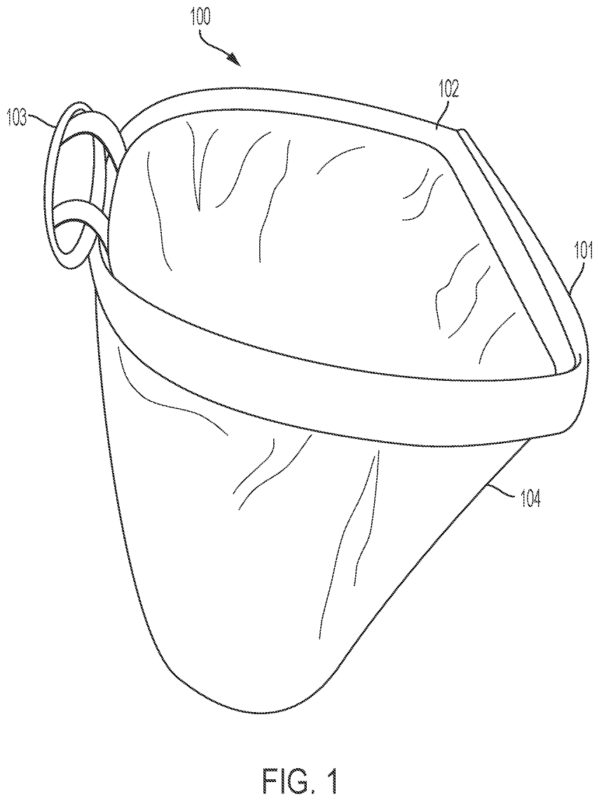

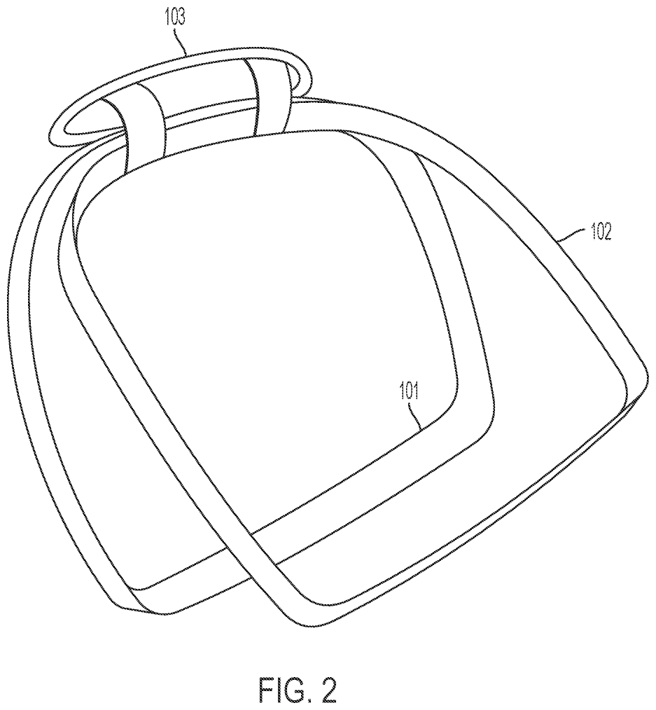

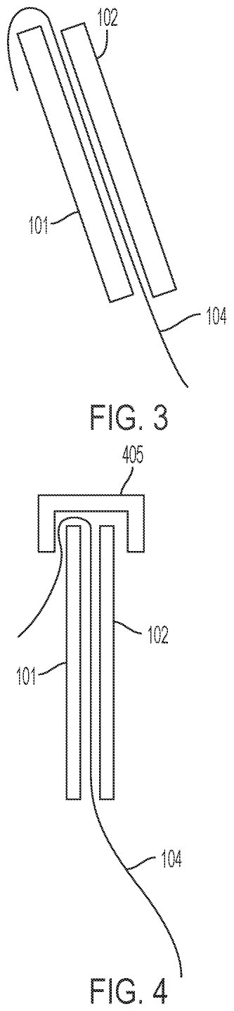

Another technique for preventing the inner portion 102 from falling through the outer portion 101 is illustrated in FIG. 4. In this example, clips 405 are employed and engaged to hold the inner portion 102 within the outer portion 101. This example illustrates the clips 405 at the top of the outer portion 101 and the inner portion 102 and overlapping the bag material 104. However, the clips 405 may be positioned at the bottom of the outer portion 101 and the inner portion 102 and may overlap the bag material 104 that is located at the bottom of the device. The clips 405 may be of different shapes, sizes, and/or configuration than illustrated in FIG. 4. For example, the clips 405 may be spring-operated clips where a spring causes the bottom ends of the clips to be drawn towards each other, thereby holding things together that are placed between these ends of the clip. As another example, the clips 405 may be formed to fit snugly over the two portions 101 and 102, thereby pressing the two portions 101 and 102 towards each other and pinning the bag material 104 between the portions. Other clip designs and configurations are possible and contemplated.

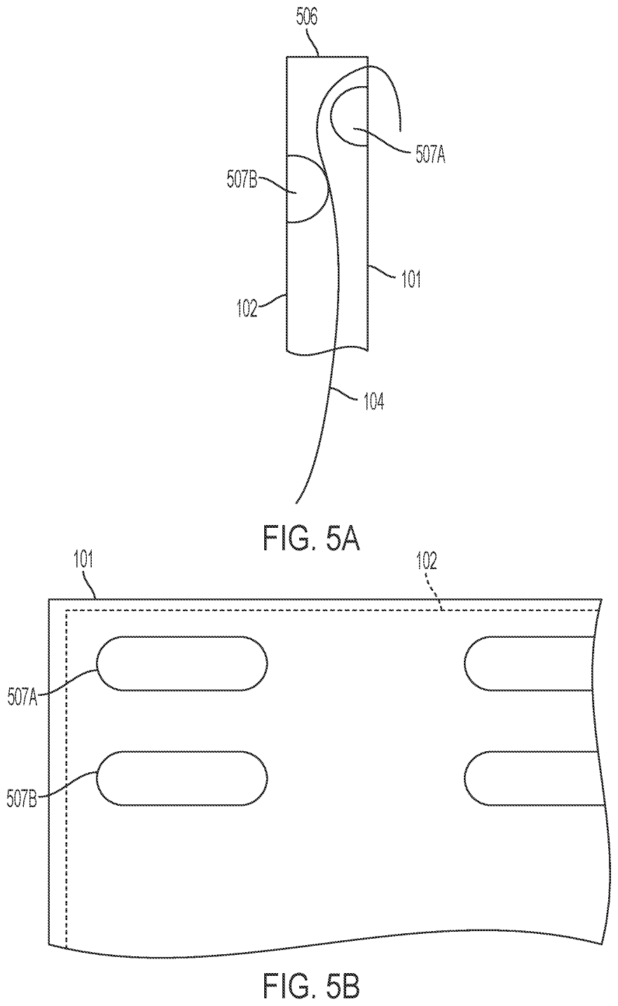

FIG. 5A illustrates another technique to prevent the inner portion 102 from falling through the outer portion 101. In this example, the inner portion 102 includes a lip 506 at the top edge of the inner portion 102. When the inner portion 102 is fit or placed within the outer portion 101, the inner portion 102 is held within the outer portion by the lip 506 of the inner portion 102 contacting the top edge of the outer portion 101. In other words, the lip 506 of the inner portion 102 catches on the outer portion 101 and prevents the inner portion 102 from falling through the outer portion 101. It should be noted that the lip 506 could be located on a bottom edge of the outer portion 101, thereby catching the inner portion 102 when the inner portion 102 is placed within the outer portion 101. The device may also include lips 506 on both the top edge of the inner portion 102 and the bottom edge of the outer portion 101.

It should be noted that a combination of techniques can be used to prevent the inner portion 102 from falling through the outer portion 101. For example, the portions may be canted and include a lip on the inner portion. It should also be noted that multiple of these techniques may be utilized to serve multiple purposes. For example, the portions may be canted to prevent the inner portion 102 from falling through the outer portion 101 and clips may be utilized to squeeze the two portions together to prevent the bag material from slipping out of the device when objects are added to the bag.

FIG. 5A also illustrates protrusions 507A and 507B that are included on the inner portion 102 and the outer portion 101. These protrusions 507A and 507B may be included to assist in holding the bag material 104 between the inner portion 102 and the outer portion 101. The outer portion 101 may include protrusions 507A on an interior side of the outer portion 101. The inner portion 102 may include protrusions 507B on an exterior side of the inner portion 102. Thus, when the two portions 101 and 102 are placed together, the protrusions 507A and 507B are facing each other. As illustrated in FIG. 5A, one set of protrusions 507A are located above the other set of protrusions 507B. This is also illustrated in FIG. 5B that illustrates a front view of the device having the protrusions 507A and 507B.

As illustrated in this front view, the protrusions 507A and 507B are located vertically in line with each other, which provides a better engagement of the bag material 104. However, it should be noted that this direct alignment is not strictly necessary. In the event that direct alignment is desired, the device may include a keying portion that aligns the protrusions 507A and 507B. The keying portion may be the flat portion, handle portion, or may be integral in the case that the two portions 101 and 102 are coupled together as opposed to two separate and separable pieces.

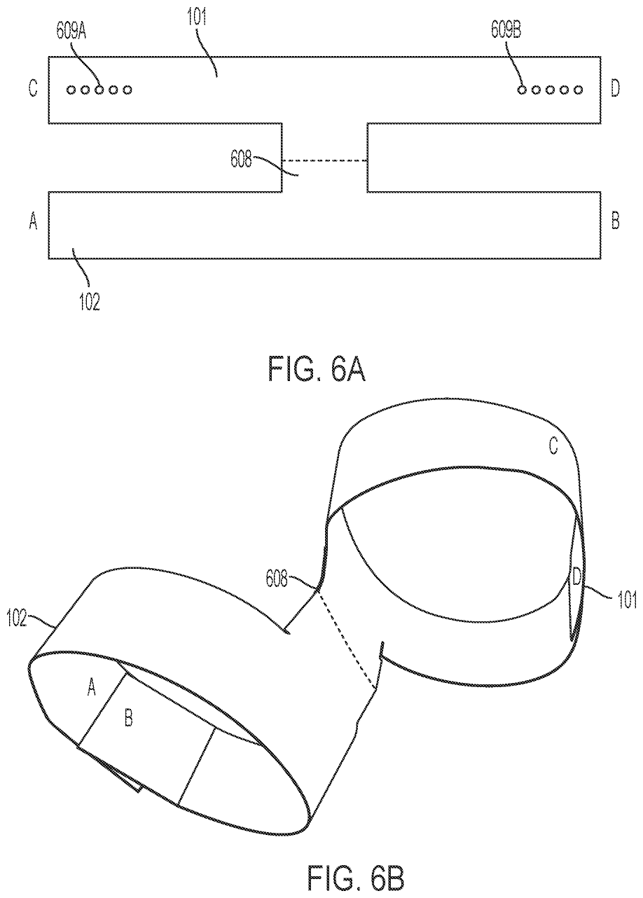

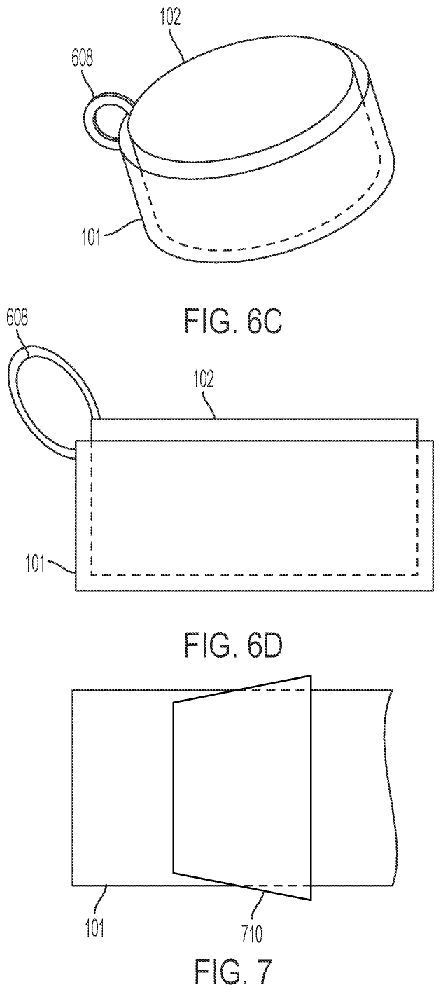

FIG. 6A-6D illustrate an example of the portable bag mouth opening device created from a single continuous piece of material. In this example, both the outer portion 102 and the inner portion 101 are connected by an inner piece 608 that, when the device is assembled and formed, can be used as a handle portion. The dotted line in the inner piece 608 of FIG. 6A, represents a folding line. This folding line is simply for illustrative purposes and, in practice, the folding line may vary position and is not necessarily a pressed folding line, meaning the device is not creased along this line. This flat version of the portable bag mouth opening device may be easier to manufacture than other examples of the device. Additionally, a flat version would allow for easier storage and/or portability than a fully assembled device. The letters A, B, C, and D, are used to provide context to the assembly shown in FIG. 6B.

FIG. 6B illustrates how the flat device illustrated in FIG. 6A can be assembled. FIG. 6B does not illustrate the final assembly, but rather an intermediate step of assembly. In FIG. 6B, the device has been folded along the folding line, point A has been bent towards point B, and point C has been bent towards point D. These bending of the portions 101 and 102 form the generally circular shape of the two assembled portions 101 and 102. As illustrated in FIG. 6B, the inner piece 608 starts to form a handle of sorts. FIG. 6C illustrates a top-side view of the two portions 101 and 102 of the flat device once the portions 101 and 102 have been fully formed into the ring forms and nested together. Also illustrated is the inner piece 608 forming the handle. FIG. 6D illustrates a side view of FIG. 6C.

As known, all bags are not the same size and have differing mouth opening sizes. To account for the different bag sizes, the device may be manufactured in different sizes, with each size corresponding to one or more bag sizes. Alternatively, the device may include adjustment mechanisms that allow for the size or diameter of the device to vary and accommodate different sizes of bags. FIG. 6A illustrates one type of adjustment mechanism 609A and 609B. This adjustment mechanism includes holes 609A and nubs 609B. One or more of the nubs 609B can be placed into one or more of the holes 609A to vary the size of the device. It should be noted that FIG. 6A only illustrates the adjustment mechanism on the outer portion 101, but, in practice, a similar adjustment mechanism would be included on the inner portion 102.

Other adjustment mechanisms can be utilized, for example, as illustrated in FIG. 7. In this example, the adjustment mechanism is a pressure buckle 710. By releasing the buckle, the pressure on one or both of the portions 101 and 102 is released, thereby allowing parts of each of the portions to be pulled apart or pushed together to vary the size of the device. Using this type of adjustment mechanism provides that a single mechanism can be used for both portions, instead of needing a separate adjustment mechanism for each portion. Other example adjustment mechanisms include friction buckles, other coupling devices (e.g., hook and loop, ridges and catches, etc.), and/or the like. The device may also include other features, for example, a loop or portion where a strap can be connected so that a user could wear the strap and carry the device with the bag without having to use hands to carry the device, a loop or hook area where the user can hang or carry other objects from the device, and/or the like.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A portable bag mouth opening device, the device comprising:
an outer portion comprising a continuous side portion defining an interior opening; and
an inner portion comprising a continuous side portion and defining an interior opening, the inner portion fitting within the outer portion to form the portable bag mouth opening device, wherein the outer portion and inner portion fit together to hold a bag material between the outer portion and the inner portion.

2. The device of claim 1, wherein the inner portion and the outer portion are produced from a single continuous piece of material.

3. The device of claim 1, wherein the continuous side portion of the outer portion and the continuous side portion of the inner portion provide a flat edge for holding the portable bag mouth opening device against a surface.

4. The device of claim 3, wherein the outer portion and the inner portion are made of a flexible material and wherein the flat edge is provided via pressing the bag mouth opening device against a surface.

5. The device of claim 3, wherein the continuous side portion of the outer portion and the continuous side portion of the inner portion are shaped having the flat edge.

6. The device of claim 1, wherein the outer portion and the inner portion are connected together via a connection mechanism.

7. The device of claim 1, wherein the continuous side portion of both the inner portion and the outer portion are canted, wherein the defined interior opening of both the inner portion and the outer portion is narrower at a bottom edge as compared to a top edge of the continuous side portion.

8. The device of claim 1, wherein the inner portion comprises a lip located at a top edge of the continuous side portion and wherein, when the inner portion is fit within the outer portion, the inner portion is held within the outer portion by the lip of the inner portion contacting a top edge of continuous side portion of the outer portion.

9. The device of claim 1, further comprising at least one clip that is engaged to hold the inner portion within the outer portion.

10. The device of claim 1, further comprising a handle.

11. The device of claim 1, further comprising a carrying strap connectable to the portable bag mouth opening device.

12. The device of claim 1, wherein the outer portion and the inner portion are made of a recycled material.

13. The device of claim 1, wherein the outer portion comprises a plurality of protrusions located on an interior side of the continuous side portion;
wherein the inner portion comprises a plurality of protrusions located on an exterior side of the continuous side portion; and
wherein the plurality of protrusions of the outer portion and the plurality of protrusions of the inner portion assist in holding the bag material between the inner portion and the outer portion.

14. The device of claim 1, wherein each of the outer portion and the inner portion comprise at least one adjusting mechanism to adjust a size of each of the outer portion and the inner portion.

15. The device of claim 1, wherein the outer portion and the inner portion are generally circular.

16. A portable bag mouth opening device, the device comprising:
an outer portion made of a flexible material and comprising a continuous side portion defining an interior opening; and
an inner portion made of a flexible material and comprising a continuous side portion and defining an interior opening, the inner portion fitting within the outer portion to form the portable bag mouth opening device, wherein the outer portion and inner portion fit together to hold a bag material between the outer portion and the inner portion;
wherein the inner portion and the outer portion are produced from a single continuous piece of material; and
wherein the continuous side portion of the outer portion and the continuous side portion of the inner portion provide a flat edge for holding the portable bag mouth opening device against a surface, wherein the flat edge is provided via pressing the bag mouth opening device against a surface.

17. The device of claim 16, wherein each of the outer portion and the inner portion comprise at least one adjusting mechanism to adjust a size of each of the outer portion and the inner portion.

18. The device of claim 16, further comprising a handle.

19. The device of claim 16, further comprising a carrying strap connectable to the portable bag mouth opening device.

20. The device of claim 16, wherein the outer portion and the inner portion are made of a recycled material.
